(19) United States
(12) Patent Application Publication
(10) Pub. No.: US 2004/0090134 A1
(43) Pub. Date: May 13, 2004

(54) Generator having a brushless excitor and power generating installation making use of the same

(75) Inventors: Kazumasa Ide, Hitachiohta (JP); Akiyoshi Komura, Hitachi (JP); Mamoru Kimura, Hitachi (JP); Shintaro Oku, Hitachi (JP); Masayuki Tani, Hitachinaka (JP)

Correspondence Address: CROWELL & MORING LLP, INTELLECTUAL PROPERTY GROUP, P.O. BOX 14300, WASHINGTON, DC, 20044-4300, US

(73) Assignee: HITACHI, LTD., TOKYO (JP)

(21) Appl. No.: 10/642,582

(22) Filed: Aug. 19, 2003

(30) Foreign Application Priority Data
Nov. 7, 2002 (JP) 2002-323264

(51) Int. Cl. H02K 7/20; H02K 17/44

(52) U.S. Cl. 310/112; 310/268; 310/114

(57) ABSTRACT

A generator comprising a generator main section having a stator provided with a winding and a rotor provided with a winding and opposed to the stator with an air gap therebetween, the rotor being rotatably supported by a rotating shaft, and an excitor having a stator provided with a winding and a rotor provided with a winding and opposed to the stator with an air gap therebetween, the rotor being rotatably supported by the rotating shaft of the generator main section, and wherein the winding provided on the rotor of the generator main section and the winding provided on the rotor of the excitor are electrically connected to each other through electronic parts, and the stator and the rotor of the excitor are opposed to each other with an air gap therebetween in a direction along the rotating shaft.

### BACKGROUND OF THE INVENTION

The present invention relates to a generator and a power generating installation making use of the same, and more particular, to a generator, in which a set of a stator and a rotor composes a generator main section and a brushless excitor for exciting the generator, and a power generating installation making use of the generator.

A generator having a conventional brushless excitor is constructed, as described in a general catalog of cogeneration systems of Yammar Ltd., page 37, (issued in November, 2001), such that a generator main section composed of a stator provided with an armature winding and a rotor provided with a field winding, between which stator and rotor an air gap is provided radially, and a brushless excitor for excitation of the generator main section and composed of a stator provided with a field winding, a rotor provided with an armature winding, and a diode mounted on a side of rotation, between which stator and rotor an air gap is provided radially, are arranged in series in a direction along a rotating shaft.

A power generating installation making use of a generator having a conventional brushless excitor comprises a prime mover such as gas engines, diesel engines, or the like, a flywheel provided for inhibiting nonuniformity in rotation of the prime mover, and a generator having the brushless excitor, the prime mover, flywheel, and the generator provided with the brushless excitor being arranged in series on the same rotating shaft.

A generator having a brushless excitor of the related art involves a problem that since a generator main section and a brushless excitor are arranged in series in a direction along a rotating shaft as described above, the generator is increased in axial length and so it is essential to ensure a predetermined space for installation in an axial direction.

### SUMMARY OF THE INVENTION

A first object of the invention is to modify a configuration of a generator having a brushless excitor to provide a generator having a brushless excitor, which is short in axial length.

Also, while it is necessary to inhibit nonuniformity in rotation of a prime mover in a power generating installation making use of a generator having a brushless excitor of the related art, a rotor involves an upper limit in outer diameter because of the need of installing a stator on an outer diametrical side of a rotor of the generator and dimensional restrictions on a rotating shaft and a surface, on which the installation is to be installed, and so an adequate effect of a flywheel cannot be expected of the single generator, which gives rise to the need of installing a flywheel separately. Accordingly, there is caused a problem that a predetermined space for installation in an axial direction must be ensured in order to install a flywheel.

A second object of the invention is to modify a configuration of a generator having a brushless excitor to provide for a flywheel effect on the generator itself having a brushless excitor to provide a power generating installation, from which a flywheel is omitted, and which comprises a prime mover and a generator having a brushless excitor and is short in axial length.

The invention has a feature in a generator and a power generating installation, comprising a generator main section having a stator provided with a winding and a rotor provided with a winding and opposed to the stator with an air gap therebetween, the rotor being rotatably supported by a rotating shaft, and an excitor having a stator provided with a winding and a rotor provided with a winding and opposed to the stator with an air gap therebetween, the rotor being rotatably supported by the rotating shaft of the generator main section, the winding provided on the rotor of the generator main section and the winding provided on the rotor of the excitor being electrically connected to each other through electronic parts, and the stator and the rotor of the excitor being opposed to each other with an air gap therebetween in a direction along the rotating shaft.

Also, the invention has a feature in a generator and a power generating installation, comprising a generator main section having a stator provided with a winding and a rotor provided with a winding and opposed to the stator in a direction along a rotating shaft with an air gap therebetween, the rotor being rotatably supported by the rotating shaft, and an excitor having a stator provided with a winding and a rotor provided with a winding and opposed to the stator in the direction along the rotating shaft with an air gap therebetween, the rotor being rotatably supported by the rotating shaft of the generator main section, the winding provided on the rotor of the generator main section and the winding provided on the rotor of the excitor being electrically connected to each other through electronic parts, and the rotor of the generator main section and the rotor of the excitor being arranged in substantially the same position in the direction along the rotating shaft.

Also, the invention has a feature in a generator and a power generating installation, comprising a generator main section having a stator provided with a winding and a rotor provided with a winding and opposed to the stator in a direction along a rotating shaft with an air gap therebetween, the rotor being rotatably supported by the rotating shaft, and an excitor having a stator provided with a winding and a rotor provided with a winding and opposed to the stator in the direction along the rotating shaft with an air gap therebetween, the rotor being rotatably supported by the rotating shaft of the generator main section, the winding provided on the rotor of the generator main section and the winding provided on the rotor of the excitor being electrically connected to each other through electronic parts, and the rotor of the generator main section and the rotor of the excitor being made of the same member.

In addition, other features of the invention are described in the claims.

### BRIEF DESCRIPTION OF THE DRAWINGS

FIG. 1 is a view showing a configuration of a generator having a brushless excitor according to a first embodiment of the invention;

FIG. 2 is a view showing a configuration of a generator having a brushless excitor according to a second embodiment of the invention;

FIG. 3 is a view showing a configuration of a generator having a brushless excitor according to a third embodiment of the invention;

FIG. 4 is a view showing a configuration of a generator having a brushless excitor according to a fourth embodiment of the invention;

FIG. 5 is a view showing a configuration of a power generating installation making use of a generator having a brushless excitor according to a fifth embodiment of the invention;

FIG. 6 is a view showing a configuration of a generator having a brushless excitor according to the related art; and

FIG. 7 is a view showing a configuration of a power generating installation making use of a generator having a brushless excitor according to the related art.

### DETAILED DESCRIPTION OF THE PREFERRED EMBODIMENTS

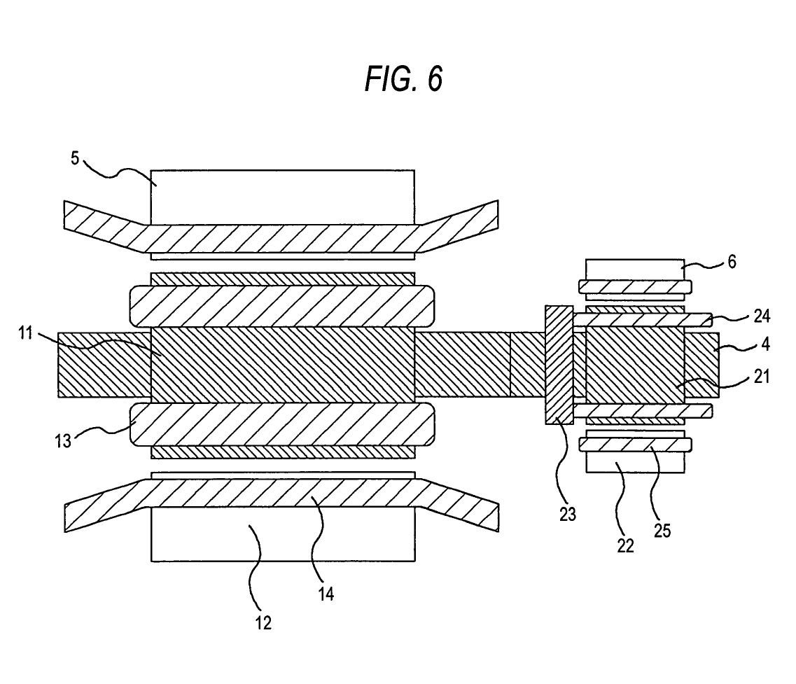

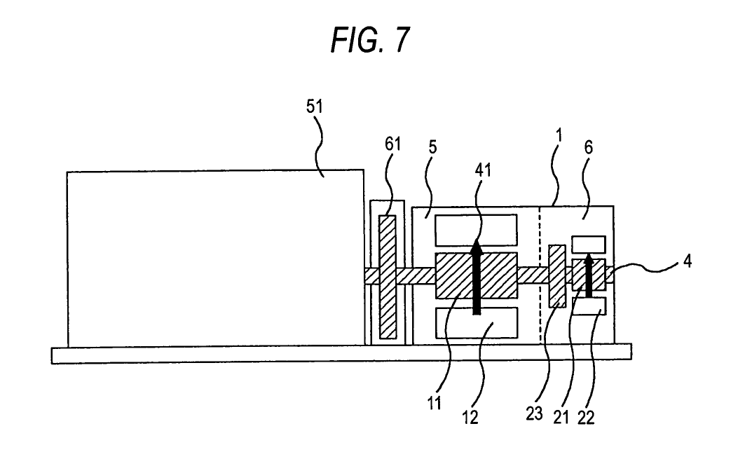

FIG. 6 shows a configuration of a generator as a comparative example for the purpose of explaining an operation and effect of the invention, and FIG. 7 shows a configuration of a power generating installation as a comparative example.

In FIG. 6, a generator main section 5, which is composed of a stator 12 made of a magnetic substance and provided with an armature winding 14 and a rotor 11 made of a magnetic substance and provided with a field winding 13 and has an air gap radially between the stator 12 and the rotor 11, and a brushless excitor 6, which is composed of a stator 22 provided with a field winding 25, a rotor 21 provided with an armature winding 24, and a diode 23 installed on a side of the rotor and has an air gap radially between the stator 6 and the rotor 21, are arranged in series in a direction along a rotating shaft to cause excitation of the generator main section 5.

Also, a power generating installation comprises, as shown in FIG. 7, a prime mover 51 such as gas engines, diesel engines, or the like, a flywheel 61 installed for inhibiting nonuniformity in rotation of the prime mover 51, and a generator having a brushless excitor 6, and the prime mover 51, flywheel 61 and the generator having the brushless excitor 6 are arranged in series on the same rotating shaft.

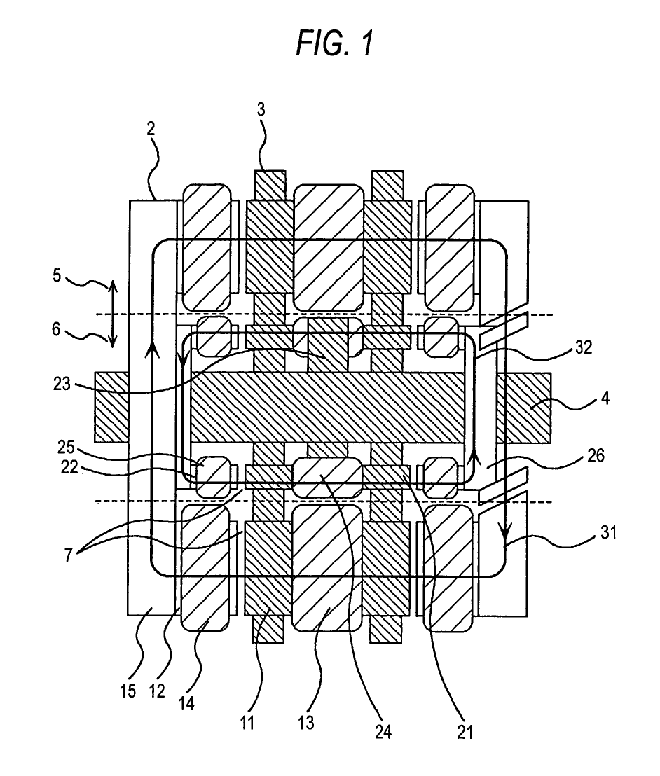

An embodiment of a generator having a brushless excitor according to the invention will be described below with reference to the accompanying drawings. FIG. 1 shows a configuration of a generator having a brushless excitor according to a first embodiment.

The generator having the brushless excitor is constructed to comprise a stator 2 and a rotor 3, which are arranged perpendicular to a rotating shaft 4 and axially opposed to each other with an air gap 7 therebetween, the stator 2 having on an outer diametrical side thereof a stator function 12 provided with an armature winding 14 of a generator main section 5 and having on an inner diametrical side (radially inward) thereof a stator function 22 provided with a field winding 25 of the brushless excitor 6, the rotor 3 having on an outer diametrical side (radially outward) thereof a rotor function 11 provided with a field winding 13 of the generator main section and having on an inner diametrical side thereof a rotor function 21 provided with an armature winding 24 of the brushless excitor. Accordingly, the rotor function of the generator main section 5 and the rotor function of the brushless excitor 6 are made of the same rotor member. A magnetic circuit on a side of the generator main section is configured such that magnetic flux circulates in a closed loop31 from the rotorfunction11 of the generator main section to the stator function 12 of the generator main section 5 and an annular stator yoke 15 through the air gap 7, and a magnetic circuit of the brushless excitor is configured such that magnetic flux circulates in a closed loop 32 from the rotor function 21 of the brushless excitor to the stator function 22 of the brushless excitor and a stator yoke 26 through the air gap 7. The stator function 12 of the generator main section and the rotor function 21 of the brushless excitor are preferably formed by laminating steel sheets since alternating current magnetic flux flows therethrough. The rotor function 11 of the generator main section and the stator function 22 of the brushless excitor may be formed by laminating steel sheets, or formed into a predetermined shape by cutting an iron core in the form of a lump since direct current magnetic flux flows therethrough. Also, electronic parts such as the diode 23, or the like are mounted on the rotor 3 to be connected to the armature winding 24 of the brushless excitor to constitute a diode bridge. Accordingly, the function of the generator main section 5 and the function of the brushless excitor 6 are configured in a plane, in which positions thereof in an axial direction are substantially the same.

Subsequently, an explanation will be given to an electric operation in the generator having the brushless excitor shown in FIG. 1. The function of the brushless excitor 6 permits a direct current to flow through the field winding 25 of the brushless excitor to cause excitation of the closed loop 32, which constitutes a magnetic circuit as the brushless excitor, to give rise to voltage in the armature winding 24 of the brushless excitor. The armature winding 24 comprises a winding of polyphase current, for example, three-phase current, and its alternating current output is rectified by the diode 23 mounted on a rotating side to be converted into a direct current. The direct current output causes excitation of the closed loop 31, which is connected to the field winding 13 of the generator main section disposed on the same rotor 3 side to constitute a magnetic circuit as the generator main section, to give rise to voltage in the armature winding 14 of the generator main section, and output of the armature winding 14 is connected to a load (not shown) to supply electricity to the load.

More specifically, magnetic flux flows in parallel to the rotating shaft through the rotor function 11 provided with the field winding 13 and the stator function 12 provided with the armature winding 14, in the closed loop 31 as the generator main section, and magnetic flux flows in parallel to the rotating shaft through the rotor function 21 provided with the armature winding 24 and the stator function 22 provided with the field winding 25, in the closed loop 32 as the brushless excitor. According to the embodiment, since the rotor 3 itself has a great moment to function as a flywheel, the flywheel can be omitted, or simplified, to be made shorter in axial length than that in the comparative example. In other words, the rotational speed can be made stable even without a flywheel, and the generator can be stably run. Also, since the number of parts is reduced, the manufacturing cost is decreased and maintenance is improved in quality.

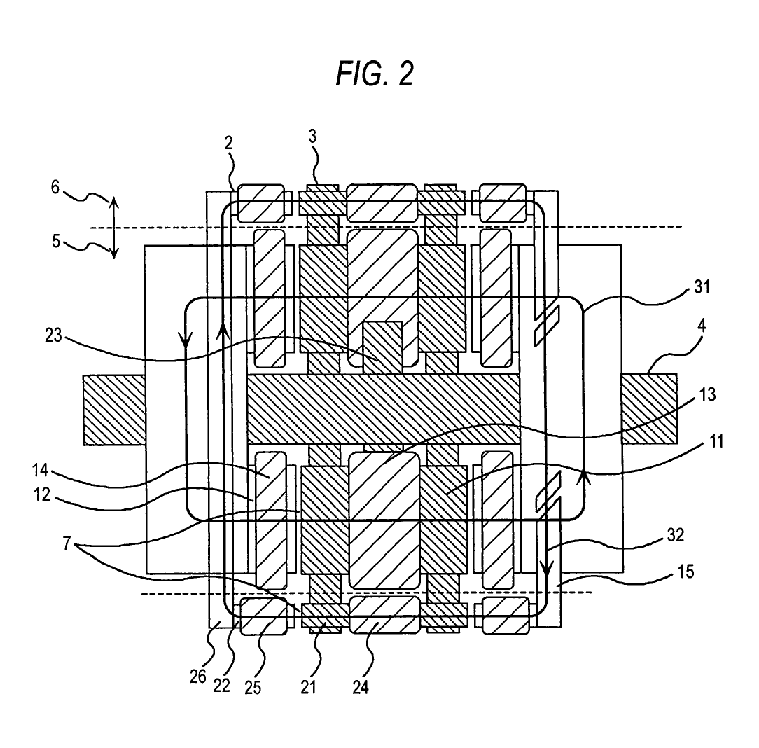

Subsequently, an explanation will be given to an embodiment of a power generating installation making use of the generator having the brushless excitor according to the invention with reference to the accompanying drawings. FIG. 2 shows a configuration of a generator having a brushless excitor according to a second embodiment. While the generator main section 5 is disposed on the outer diametrical side and the brushless excitor 6 is disposed on the inner diametrical side in the configuration of FIG. 1, a generator main section 5 is disposed on an inner diametrical side and a brushless excitor 6 is disposed on an outer diametrical side in the present embodiment. The generator having a brushless excitor 6 is constructed to comprise a stator 2 and a rotor 3, which are arranged perpendicular to a rotating shaft 4 and axially opposed to each other with an air gap 7 therebetween, the stator 2 having on an inner diametrical side thereof a stator function 12 provided with an armature winding 14 of the generator main section 5 and having on an outer diametrical side thereof a stator function 22 provided with a field winding 25 of the brushless excitor 6, the rotor 3 having on an inner diametrical side thereof a rotor function 11 provided with a field winding 13 of the generator main section and having on an outer diametrical side thereof a rotor function 21 provided with an armature winding 24 of the brushless excitor. That is, a magnetic circuit on a side of the generator main section is configured such that magnetic flux circulates in a closed loop 31 from the rotor function 11 of the generator main section to the stator function 12 of the generator main section and a stator yoke 15 through the air gap 7, and a magnetic circuit of the brushless excitor is configured such that magnetic flux circulates in a closed loop 32 from the rotor function 21 of the brushless excitor to the stator function 22 of the brushless excitor and a stator yoke 26 through the air gap 7. Also, a diode 23 is mounted on the rotor 3 to be connected to the armature winding 24 of the brushless excitor to constitute a diode bridge.

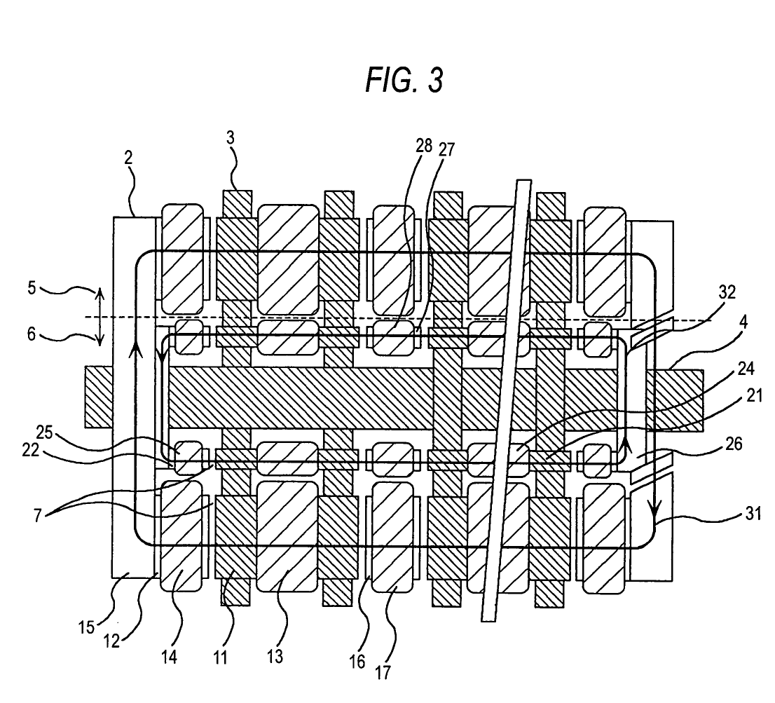

FIG. 3 shows a configuration of a generator having a brushless excitor according to a third embodiment. The stators 2 are disposed on both axial sides of the rotor 3 in the configuration shown in FIG. 1, while a plurality of rotors 3 in the embodiment are provided in an axial direction to arrange therebetween stator functions 16 without any yoke and armature windings 17 provided on the stator functions 16 to form a magnetic circuit of a generator main section, and to arrange therebetween stator functions 27 without any yoke and field windings 28 provided on the stator functions 27 to form a magnetic circuit of a brushless excitor.

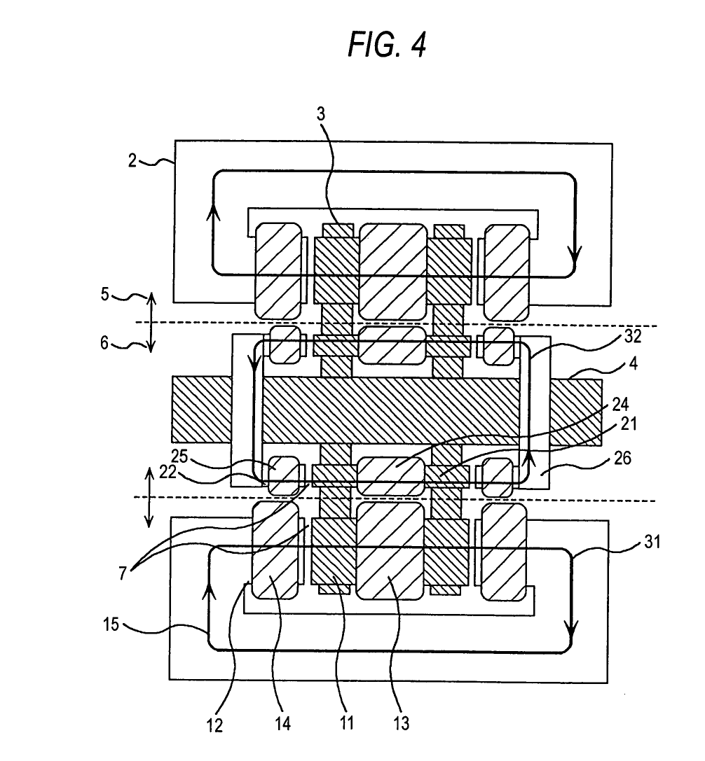

FIG. 4 shows a configuration of a generator having a brushless excitor according to a fourth embodiment. The stator yoke 15 of the generator main section is made annular and mounted on the axial end to flow therethrough magnetic flux in the configuration shown in FIG. 1, while according to the embodiment a stator yoke 15 is extended to an outer diametrical side of rotors from a stator function 12 on one end to be connected to a stator function on the other end. Since alternating current magnetic flux flows through the stator yoke 15, it is preferable to laminate steel sheets to form the yoke.

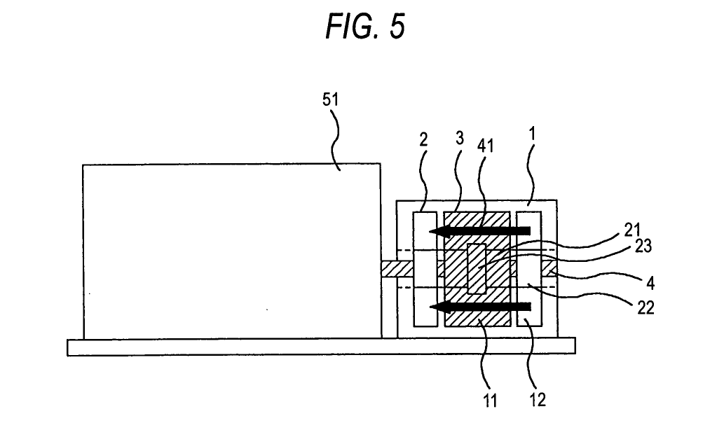

FIG. 5 shows a configuration of a power generating installation making use of a generator having a brushless excitor according to a fifth embodiment. The generator 1 having the brushless excitor is constructed to comprise a stator 2 and a rotor 3, which are arranged perpendicular to a rotating shaft 4 and opposed to each other, the stator 2 having on an outer diametrical side thereof a stator function 12 of a generator main section and having on an inner diametrical side thereof a stator function 22 of the brushless excitor, the rotor 3 having on an outer diametrical side thereof a rotor function 11 of the generator main section and having on an inner diametrical side thereof a rotor function 21 of the brushless excitor. The rotating shaft 4 is axially connected in series to a prime mover 51, such as gas engines, diesel engines, or the like, for converting reciprocating motion into rotary motion to produce a mechanical output.

In the above embodiments, the function of the brushless excitor 6 and the function of the generator main section 5 are arranged in substantially the same position in the axial direction to comprise common stators 2 and rotors 3, while even in the case where the function of the brushless excitor 6 and the function of the generator main section 5 are arranged in different positions in the axial direction to comprise separate stators and rotors and the function of the brushless excitor 6 is configured such that a stator and a rotor are axially opposed to each other with an air gap therebetween, the function of the brushless excitor 6 has a great moment to function as a flywheel, thereby enabling omitting a flywheel, and the generator can be made shorter in axial length than the comparative example. However, that configuration, in which the function of the generator main section 5 and the function of the brushless excitor 6 comprise common stators and rotors, is excellent in that it is compact and small in the number of parts to be good in maintenance.

A generator having the brushless excitor described above, according to the invention, is made short in axial length.

More specifically, since a generator having a brushless excitor is composed of a stator 2 having a stator function 12 of a generator main section and a stator function 22 of a brushless excitor in the same position in an axial direction, and a rotor 3 having a rotor function 11 of the generator main section and a rotor function 21 of the brushless excitor in the same position, which is different from the former position, in the axial direction, it can be made compact in axial length.

Also, a power generating installation making use of the generator having the brushless excitor according to the invention is made short in axial length.

More specifically, since a generator having a brushless excitor is composed of a stator 2 having a stator function 12 of a generator main section and a stator function 22 of a brushless excitor in the same position in an axial direction, and a rotor 3 having a rotor function 11 of the generator main section and a rotor function 21 of the brushless excitor in the same position, which is different from the former position, in the axial direction, the rotor 3 can be increased in outer diameter and the rotor 3 itself can posses the effect of a flywheel, so that there is no need for installation of a flywheel and a power generating installation can be composed of only a prime mover and a generator having a brushless excitor, thus enabling making the axial length compact.

What is claimed is:

1. A generator comprising a generator main section having a stator provided with a winding and a rotor provided with a winding and opposed to the stator with an air gap therebetween, the rotor being rotatably supported by a rotating shaft, and
an excitor having a stator provided with a winding and a rotor provided with a winding and opposed to the stator with an air gap therebetween, the rotor being rotatably supported by the rotating shaft of the generator main section, and
wherein the winding provided on the rotor of the generator main section and the winding provided on the rotor of the excitor are electrically connected to each other through electronic parts, and
the stator and the rotor of the excitor are opposed to each other with an air gap therebetween in a direction along the rotating shaft.

2. A generator comprising a generator main section having a stator provided with a winding and a rotor provided with a winding and opposed to the stator in a direction along a rotating shaft with an air gap therebetween, the rotor being rotatably supported by the rotating shaft, and
an excitor having a stator provided with a winding and a rotor provided with a winding and opposed to the stator in the direction along the rotating shaft with an air gap therebetween, the rotor being rotatably supported by the rotating shaft of the generator main section, and
wherein the winding provided on the rotor of the generator main section and the winding provided on the rotor of the excitor are electrically connected to each other through electronic parts, and
the rotor of the generator main section and the rotor of the excitor are arranged in substantially the same position in the direction along the rotating shaft.

3. A generator comprising a generator main section having a stator provided with a winding and a rotor provided with a winding and opposed to the stator in a direction along a rotating shaft with an air gap therebetween, the rotor being rotatably supported by the rotating shaft, and
an excitor having a stator provided with a winding and a rotor provided with a winding and opposed to the stator in the direction along the rotating shaft with an air gap therebetween, the rotor being rotatably supported by the rotating shaft of the generator main section, and
wherein the winding provided on the rotor of the generator main section and the winding provided on the rotor of the excitor are electrically connected to each other through electronic parts, and
the rotor of the generator main section and the rotor of the excitor are made of the same member.

4. The generator according to claim 2, wherein the stator of the generator main section is arranged on an outer diametrical side from the stator of the excitor, and
the rotor of the generator main section is arranged on an outer diametrical side from the rotor of the excitor.

5. The generator according to claim 2, wherein the stator of the generator main section is arranged on an inner diametrical side from the stator of the excitor, and
the rotor of the generator main section is arranged on an inner diametrical side from the rotor of the excitor.

6. The generator according to claim 2, wherein the rotors of the excitor are arranged in plural in the direction along the rotating shaft.

7. The generator according to claim 4, wherein the stators of the generator main section are arranged on both axial sides of the rotor of the generator main section, and one of the stators of the generator main section is connected to the other of the stators from the outer diametrical side of the rotor of the generator main section.

8. A power generating installation provided with the generator according to claim 1, wherein the rotating shaft is connected to a prime mover and a mechanical output generated by the prime mover is input into the rotating shaft.

9. A power generating installation provided with the generator according to claim 2, wherein the rotating shaft is connected to a prime mover and a mechanical output generated by the prime mover is input into the rotating shaft.

10. A power generating installation provided with the generator according to claim 3, wherein the rotating shaft is connected to a prime mover and a mechanical output generated by the prime mover is input into the rotating shaft.
